(19) United States
(12) Patent Application Publication
(10) Pub. No.: US 2026/0162517 A1
(43) Pub. Date: Jun. 11, 2026

(54) MANUAL INITIATING DEVICE ISOLATION AND TESTING

(71) Applicant: Honeywell International Inc., Charlotte, NC (US)

(72) Inventors: Benjamin Henry Wolf, Leicester (GB); Michael Barson, Nuneaton (GB); Christopher Dearden, Melton Mowbray (GB)

(21) Appl. No.: 18/973,741

(22) Filed: Dec. 9, 2024

(51) Int. Cl. G08B 29/02; G08B 5/36

(52) U.S. Cl. CPC G08B 29/02; G08B 5/36

(57) ABSTRACT

Manual initiating device isolation and testing is described herein. One manual initiating device includes a switch configured to activate a fire alarm system and a controller configured to receive a command to enter the manual initiating device into a test mode, indicate the manual initiating device is in the test mode in response to receiving the command to enter the test mode, receive an actuation of the switch while the manual initiating device is in the test mode, and indicate the manual initiating device has been tested in response to the actuation of the switch.

### TECHNICAL FIELD

The present disclosure relates generally to manual initiating device isolation and testing.

### BACKGROUND

Large facilities (e.g., buildings), such as commercial facilities, office buildings, hospitals, and the like, may have a fire alarm system that can be triggered during an emergency situation (e.g., a fire) to warn occupants to evacuate. For example, a fire alarm system may include a fire control panel, a plurality of fire sensing devices (e.g., smoke detectors) and a plurality of manual initiating devices (e.g., call points or pull stations) located throughout the facility (e.g., on different floors and/or in different rooms of the facility) that can be triggered by an occupant to trigger a notification of a fire to other occupants of the facility via alarms.

Maintaining the fire alarm system can include regular testing of fire sensing devices and manual initiating devices mandated by codes of practice in an attempt to ensure that the fire sensing devices and manual initiating devices are functioning properly. However, in order to test manual initiating devices, the fire alarm system is isolated and placed in a test mode.

### BRIEF DESCRIPTION OF THE DRAWINGS

FIG. 1 illustrates a block diagram of a manual initiating device in accordance with an embodiment of the present disclosure.

FIG. 2 illustrates an example of a manual initiating device in accordance with an embodiment of the present disclosure.

FIG. 3 illustrates a block diagram of a mobile device in accordance with an embodiment of the present disclosure.

FIG. 4 illustrates a block diagram of a fire control panel in accordance with an embodiment of the present disclosure.

FIG. 5 illustrates a fire control system in accordance with an embodiment of the present disclosure.

FIG. 6 illustrates a fire control system in accordance with an embodiment of the present disclosure.

### DETAILED DESCRIPTION

Manual initiating device (e.g., initiating device) isolation and testing are described herein. One initiating device includes a switch configured to activate a fire alarm system and a controller configured to receive a command to enter the initiating device into a test mode, indicate the manual initiating device is in the test mode in response to receiving the command to enter the test mode, receive an actuation of the switch while the initiating device is in the test mode, and indicate the manual initiating device has been tested in response to the actuation of the switch.

Previous initiating devices require a fire alarm system or zones including a plurality of initiating devices of the fire alarm system to be isolated to test a single initiating device. This prevents the fire alarm system or the isolated zone of the fire alarm system from detecting a real fire if a fire starts during the test.

In contrast, initiating devices in accordance with the present disclosure can be placed in a test mode while the rest of the fire alarm system can remain active to detect a real fire. Accordingly, testing initiating devices in accordance with the present disclosure can help maintain the safety of the building and its inhabitants as occupants, maintenance engineers, and/or first responders can tell if a real fire event is occurring during the testing.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

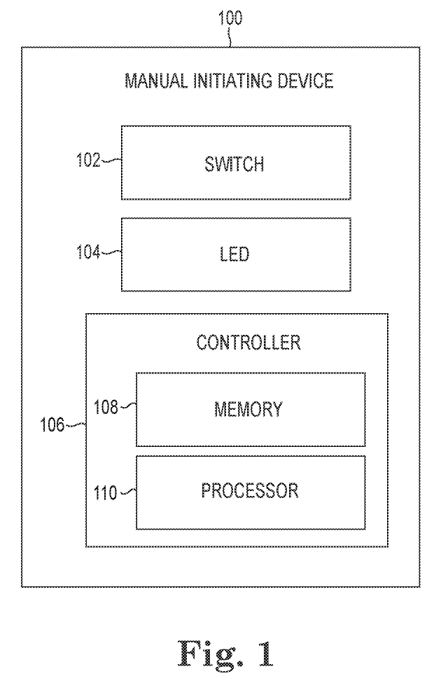

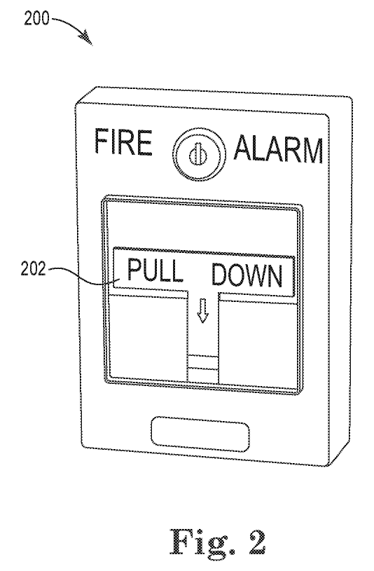

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 illustrates a block diagram of a self-testing manual initiating device 100 in accordance with an embodiment of the present disclosure. The initiating device 100 can include a switch 102, a light-emitting diode (LED) 104, and/or a controller (e.g., microcontroller) 106. The initiating device 100 can be a component of a fire alarm system of a facility (e.g., building). In some examples, the initiating device 100 can be a pull station or can include a glass element to break in order to sound a fire alarm and/or initiate an evacuation of the building.

The controller 106 can include a memory 108 and a processor 110. Memory 108 can be any type of storage medium that can be accessed by processor 110 to perform various examples of the present disclosure. For example, memory 108 can be a non-transitory computer readable medium having computer readable instructions (e.g., computer program instructions) stored thereon that are executable by processor 110 to enter a test mode in accordance with the present disclosure. For instance, processor 110 can execute the executable instructions stored in memory 108 to receive a command to enter the initiating device 100 into a test mode, indicate the initiating device 100 is in the test mode in response to receiving the command to enter the test mode, receive an actuation of the switch 102 while the initiating device 100 is in the test mode, and indicate the initiating device 100 has been tested in response to the actuation of the switch 102.

The command to enter into the test mode can be received from a control panel of the fire alarm system and/or a mobile device. In some examples, the controller 106 can isolate the initiating device 100 from other components of the fire alarm system in response to receiving the command to enter into the test mode. The initiating device 100 can indicate that it is in the test mode in response to the initiating device 100 being isolated from the other components of the fire alarm system. Isolating the initiating device 100 from other components of the fire alarm system can prevent the initiating device 100 from activating (e.g., triggering) a fire alarm of the fire alarm system.

The initiating device 100 can indicate that it is in the test mode, isolated from the other components of the fire alarm system, no longer in test mode, and/or no longer isolated from the other components of the fire alarm system using types of sounds, constant sounds, intermittent sounds, colored lights, constant lights, and/or intermittent lights. For example, the initiating device 100 can include a light-emitting diode (LED) 104. The LED 104 can indicate the initiating device 100 is in the test mode and/or has been tested. In a number of embodiments, the light can be emitted via the LED 104 in response to the initiating device 100 being isolated from other components of the fire alarm system.

A user can activate the switch 102 subsequent to isolating the initiating device 100 from other components of the fire alarm system. In a number of embodiments, the initiating device 100 can report the initiating device 100 was tested and the date it was tested in response to the switch 102 being activated subsequent to isolating the initiating device 100 from the other components of the fire alarm system.

The controller 106 can receive a command to cease (e.g., exit) the test mode. Subsequent to ceasing the test mode, a user can activate the switch 102. The initiating device 100 can activate the fire alarm of the fire alarm system in response to the switch 102 of the initiating device 100 being activated subsequent to ceasing the test mode, as the initiating device 100 is no longer isolated from the other components of the fire alarm system.

FIG. 2 illustrates an example of a self-testing manual initiating device 200 in accordance with an embodiment of the present disclosure. Initiating device 200 can correspond to initiating device 100 of FIG. 1. As previously described in connection with FIG. 1, the initiating device 200 can include a switch 202, which can correspond to switch 102 of FIG. 1.

In a number of embodiments, the initiating device 200 can be isolated from the other components of (e.g., from the rest of) the fire alarm system in response to the initiating device 200 entering into a test mode. Isolating the initiating device 200 can prevent a false alarm. For example, activating the switch 202 of the initiating device 200 without having first isolated the initiating device 200 would sound a fire alarm. As such, isolating the initiating device 200 from the rest of the fire alarm system prevents the fire alarm from sounding when activating the switch 202 of the initiating device 200.

Once the initiating device 200 has been tested, the initiating device 200 can be removed from the test mode and revert to a non-test (e.g., operational) mode to enable a user (e.g., person) to activate the fire alarm (e.g., subsequent to removing the initiating device 200 from the test mode, a fire alarm can be activated in response to the user activating (e.g., pulling) the switch 202). The initiating device 200 can be removed from the test mode in response to receiving a command to cease the test mode, for example.

In a number of embodiments, the activation of the switch 202 can be reported. A non-activation of the switch 202 can also be reported. Further, a ceasing of the activation of the switch 202, the switch 202 returning to the non-active position, and/or the switch 202 failing to return to the non-active position can also be reported.

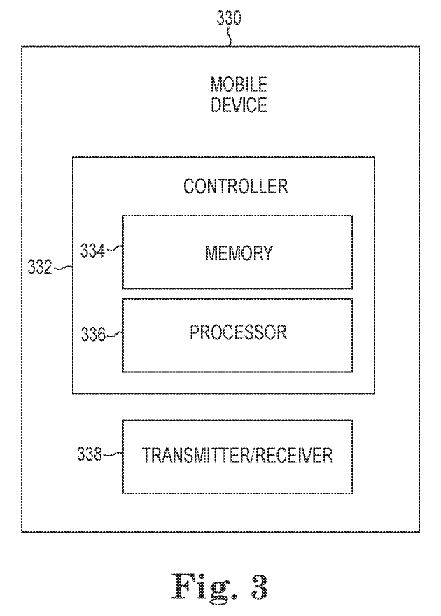

FIG. 3 illustrates a block diagram of a mobile device 330 in accordance with an embodiment of the present disclosure. The mobile device 330 can be a computing device, a personal laptop computer, a smart phone, a tablet, a wrist-worn device, and/or redundant combinations thereof, among other types of computing devices. The mobile device 330 can include a controller (e.g., microcontroller) 332 and a transmitter/receiver 338.

The controller 332 can include a memory 334 and a processor 336. Memory 334 can be any type of storage medium that can be accessed by processor 336 to perform various examples of the present disclosure. For example, memory 334 can be a non-transitory computer readable medium having computer readable instructions (e.g., computer program instructions) stored thereon that are executable by processor 336 to transmit a command to an initiating device (e.g., initiating device 100 and 200 of FIGS. 1 and 2, respectively. In some examples, the mobile device 330 can transmit the command via the transmitter/receiver 338. The initiating device can enter a test mode in response to receiving the command.

In a number of embodiments, the mobile device 330 can include a transceiver, for example, a Bluetooth Low Energy (BLE) transceiver. The mobile device 330 can transmit the command in response to the initiating device being within a wireless range, for example, a Bluetooth Low Energy (BLE) range, of the mobile device 330.

Although not illustrated in FIG. 3, the mobile device 330 can include a user interface. A user can select, via the user interface, an initiating device, a zone of a fire alarm system associated with the initiating device, and/or a loop of the fire alarm system associated with the initiating device. In some examples, the mobile device 330 can run an application and the user can select the initiating device, the zone, or the loop in the application. The mobile device 330 can transmit a command to place the initiating device, components of the zone, or components of the loop in a test mode in response to receiving, by the mobile device 330, a selection of the initiating device, the zone, or the loop. The initiating device, the components of the zone, or the components of the loop can isolate themselves from the rest of the fire alarm system in response to receiving the command.

In some examples, the user can select to cease the test mode via the user interface of the mobile device 330 and transmit a command to cease the test mode. The initiating device, the components of the zone, or the components of the loop can cease the test mode in response to receiving the command to cease the test mode.

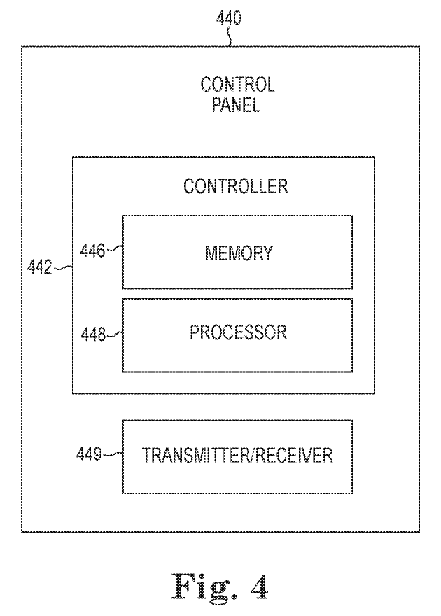

FIG. 4 illustrates a block diagram of a fire control panel (e.g., control panel) 440 in accordance with an embodiment of the present disclosure. The control panel 440 can be a computing device, a monitoring device, or a fire detection control system of a fire alarm system (e.g., the same fire alarm system that includes initiating device 100 and/or 200). The control panel 440 can include a controller 442 and a transmitter/receiver 449.

The controller 442 can include a memory 446 and a processor 448. Memory 446 can be any type of storage medium that can be accessed by processor 448 to perform various examples of the present disclosure. For example, memory 446 can be a non-transitory computer readable medium having computer readable instructions (e.g., computer program instructions) stored thereon that are executable by processor 448 to communicate with an initiating device (e.g., initiating device 100 and 200 in FIGS. 1 and 2, respectively) in accordance with the present disclosure. For instance, processor 448 can execute the executable instructions stored in memory 446 to transmit a command to the initiating device, a zone associated with the initiating device, or a loop associated with the initiating device in response to receiving, by the control panel 440, a selection of the initiating device, the zone, or the loop. The command can be a command for the initiating device, the zone, or the loop to enter a test mode and/or isolate itself.

In a number of embodiments, an additional command can be transmitted to an additional initiating device to enter the test mode and/or isolate itself. In some examples, the control panel 440 can transmit the command to the initiating device and/or transmit the additional command to the additional initiating device in response to receiving a command from a mobile device. The command and/or the additional command can be transmitted via the transmitter/receiver 449.

The additional initiating device can receive the additional command and enter into the test mode in response to receiving the additional command. Further, the additional initiating device can isolate itself from other components of the fire alarm system in response to entering the test mode and indicate the additional initiating device is in the test mode in response to being isolated from the other components of the fire alarm system.

In a number of embodiments, the control panel 440 can receive a report from the initiating device via the transmitter/receiver 449. The report can include whether a user was able to actuate a switch (e.g., switch 102 and/or 202 of FIGS. 1, 2, and 3, respectively) or failed to actuate the switch as part of a test of the initiating device. If the switch was actuated, the test of the initiating device can be determined to be successful. If the switch failed to actuate, the test of the initiating device can be determined to have failed.

The control panel 440 can receive a report from the initiating device and/or transmit another command to the initiating device via transmitter/receiver 449. For example, the control panel 440 can transmit a command to cease the test mode of the initiating device in response to receiving the report from the initiating device. If the test was successful, the control panel 440 can send a command to cease the test mode to allow the initiating device to revert back to being enabled to activate a fire alarm. If the test failed, the control panel 440 can send a command to retry the test. The control panel 440 can be configured to send commands to and/or receive reports from a number of initiating devices or fire sensing devices via a wired or wireless network.

Although not illustrated in FIG. 4, in a number of embodiments, the control panel 440 can include a user interface. The user interface can be a GUI that can provide and/or receive information to and/or from a user and/or the initiating device. The user interface can display messages and/or data received from the initiating device. For example, the user interface can alert a user to a successful or failed test of the initiating device.

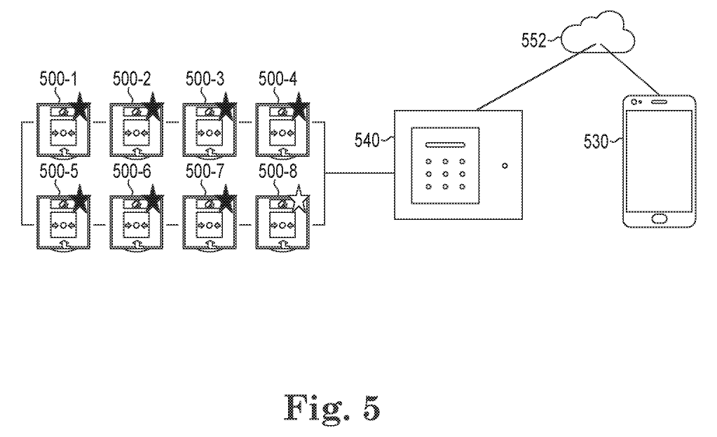

FIG. 5 illustrates a fire control system in accordance with an embodiment of the present disclosure. The fire control system can include a number of initiating devices 500-1, 500-2, 500-3, 500-4, 500-5, 500-6, 500-7, and 500-8, a control panel 540, a cloud computing device 552, and a mobile device 530. The initiating devices 500-1, 500-2, 500-3, 500-4, 500-5, 500-6, 500-7, and 500-8 can correspond to initiating device 100 and 200 of FIGS. 1 and 2, respectively. The control panel 540 can correspond to control panel 440 of FIG. 4 and the mobile device 530 can correspond to mobile device 330 of FIG. 3.

The initiating devices 500-1, 500-2, 500-3, 500-4, 500-5, 500-6, 500-7, and 500-8, the control panel 540, the cloud computing device 552, and the mobile device 530 can communicate with each other via a wired or wireless network. For example, the mobile device 530, the cloud computing device 552, and/or the control panel 540 can transmit a command (e.g., to enter test mode and/or isolate) to each of the initiating devices 500-1, 500-2, 500-3, 500-4, 500-5, 500-6, 500-7, and 500-8 via the network. In a number of embodiments, each of the initiating devices 500-1, 500-2, 500-3, 500-4, 500-5, 500-6, 500-7, and 500-8 can transmit a report to the mobile device 530, the cloud computing device 552, and/or the control panel 540 via the network, and the mobile device 530 can display the report.

The networks described herein can be a network relationship through which initiating devices 500-1, 500-2, 500-3, 500-4, 500-5, 500-6, 500-7, and 500-8, the control panel 540, the cloud computing device 552, and the mobile device 530 can communicate with each other. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive information from and transmit information to the initiating devices 500-1, 500-2, 500-3, 500-4, 500-5, 500-6, 500-7, and 500-8, the control panel 540, the cloud computing device 552, and the mobile device 530 via a wired or wireless network.

As used herein, a “network” can provide a communication system that directly or indirectly links two or more computers and/or peripheral devices and allows a mobile device 530 to access data and/or resources on the initiating devices 500-1, 500-2, 500-3, 500-4, 500-5, 500-6, 500-7, and 500-8, the control panel 540, the cloud computing device 552, and vice versa. A network can allow users to share resources on their own systems with other network users and to access information on centrally located systems or on systems that are located at remote locations. For example, a network can tie a number of computing devices together to form a distributed control network (e.g., cloud computing device 552).

A network may provide connections to the Internet and/or to the networks of other entities (e.g., organizations, institutions, etc.). Users may interact with network-enabled software applications to make a network request, such as to get data. Applications may also communicate with network management software, which can interact with network hardware to transmit information between devices on the network.

In some examples, the network can be used by the initiating devices 500-1, 500-2, 500-3, 500-4, 500-5, 500-6, 500-7, and 500-8 and/or control panel 540 to communicate with the mobile device 530. The mobile device 530 can be a personal laptop computer, a smart phone, a tablet, a wrist-worn device, and/or redundant combinations thereof, among other types of computing devices.

In a number of embodiments, the control panel 540 and/or the mobile device 530 can transmit a command to the initiating devices 500-1, 500-2, 500-3, 500-4, 500-5, 500-6, 500-7, and 500-8. For example, the control panel 540 and/or the mobile device 530 can transmit a command to initiating device 500-1 to enter a test mode. The initiating device 500-1 can receive the command and enter the test mode in response to receiving the command. In response to entering the test mode, the initiating device 500-1 can isolate itself from other components of a fire alarm system.

In some examples, the control panel 540 and/or the mobile device 530 can select a zone or a loop associated with initiating device 500-1. The zone or loop can include initiating devices 500-1, 500-2, 500-3, 500-4, 500-5, 500-6, 500-7, and 500-8. Accordingly, initiating devices 500-1, 500-2, 500-3, 500-4, 500-5, 500-6, 500-7, and 500-8 can be isolated from other components of the fire alarm system in response to a user selecting the zone or loop.

In a number of embodiments, each of the initiating devices 500-1, 500-2, 500-3, 500-4, 500-5, 500-6, 500-7, and 500-8 can emit a light via an LED (e.g., LED 104 of FIG. 1) in response to receiving the command to enter the test mode. The emitted light can be an intermittent light (e.g., flashing) or a constant light. Once an initiating device of the initiating devices 500-1, 500-2, 500-3, 500-4, 500-5, 500-6, 500-7, and 500-8 receives an actuation of its switch, its LED can cease to emit light.

As illustrated, in FIG. 5, initiating devices 500-1, 500-2, 500-3, 500-4, 500-5, 500-6, and 500-7 are emitting light, which is illustrated as a black star while initiating device 500-8 has ceased emitting light, which is illustrated as a black outlined star. As such, initiating device 500-8 has been tested by the user actuating its switch and in some examples is no longer isolated from the rest of the fire alarm system. Meanwhile, initiating devices 500-1, 500-2, 500-3, 500-4, 500-5, 500-6, and 500-7 are waiting to be tested by the user and are still isolated from the rest of the fire alarm system. In some examples, initiating device 500-8 can cease the test mode in response to the actuation of the switch.

The initiating device 500-1 can transmit a report to the control panel 540 in response to a user activating a switch. In some examples, in response to receiving the report, the control panel 540 can transmit a command to cease the test mode to the initiating device 500-1. The initiating device 500-1 can cease the test mode in response to receiving the command to cease the test mode.

Each of the initiating devices 500-1, 500-2, 500-3, 500-4, 500-5, 500-6, 500-7, and 500-8 can transmit a report to the control panel 540 in response to activating or failing to activate the switch. In a number of embodiments, the control panel 540 can flag the failure by transmitting the failure to the cloud computing device 552 and/or the mobile device 530. The cloud computing device 552 can store the failure in memory. The mobile device 530 can convey the failure to a user to have the user try to activate the switch again.

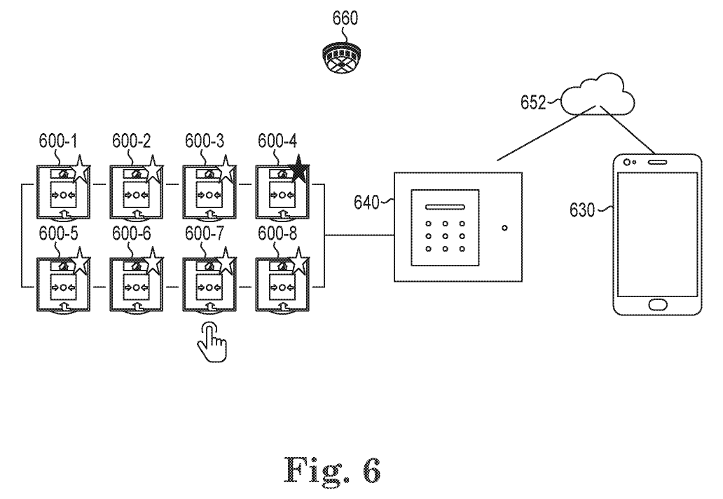

FIG. 6 illustrates a fire control system in accordance with an embodiment of the present disclosure. The fire control system can include a number of initiating devices 600-1, 600-2, 600-3, 500-4, 600-5, 600-6, 600-7, and 600-8, a control panel 640, a cloud computing device 652, and a mobile device 630. The initiating devices 600-1, 600-2, 600-3, 600-4, 600-5, 600-6, 600-7, and 600-8 can correspond to initiating device 100, 200, and 500-1, 500-2, 500-3, 500-4, 500-5, 500-6, 500-7, and 500-8 of FIGS. 1, 2, and 5, respectively. The control panel 640 can correspond to control panel 440 and 540 of FIGS. 4 and 5, respectively.

As illustrated, in FIG. 6, initiating device 600-4 is emitting light, which is shown as a black star while initiating devices 600-1, 600-2, 600-3, 600-5, 600-6, 600-7, and 600-8 have ceased emitting light, which are shown as black outlined stars. As such, initiating devices 600-1, 600-2, 600-3, 600-5, 600-6, 600-7, and 600-8 have been tested by the user actuating their switches and initiating device 600-4 is waiting to be tested by the user and is isolated from a portion of a fire alarm system.

In a number of embodiments, the mobile device 630 can isolate one or more of the initiating devices 600-1, 600-2, 600-3, 600-5, 600-6, 600-7, and 600-8 from components of the fire alarm system in response to the one or more of the initiating devices 600-1, 600-2, 600-3, 600-5, 600-6, 600-7, and 600-8 or an adjacent fire sensing device 660 being within a wireless range of the mobile device 630. The wireless range can be a Bluetooth Low Energy (BLE) range. For example, the mobile device 630 and the initiating device 600-4 and/or the fire sensing device 660 can each include a BLE transceiver. In a number of embodiments, the fire sensing device 660 can be within BLE range of the mobile device 630. Accordingly, the initiating device 600-4 known to be located adjacent to the fire sensing device 660 can be isolated from the rest of the fire alarm system and tested by the user.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A manual initiating device, comprising:
a switch configured to activate a fire alarm system; and
a controller configured to:
receive a command to enter the manual initiating device into a test mode;
indicate the manual initiating device is in the test mode
in response to receiving the command to enter the test mode;
receive an actuation of the switch while the manual initiating
device is in the test mode; and
indicate the manual initiating device has been tested in response to the actuation of the switch.

2. The device of claim 1, wherein the controller is configured to cease the test mode in response to the actuation of the switch.

3. The device of claim 1, wherein the controller is configured to receive a command to cease the test mode.

4. The device of claim 1, further comprising a light-emitting diode (LED), wherein the LED is configured to indicate the manual initiating device is in the test mode.

5. The device of claim 1, further comprising a light-emitting diode (LED), wherein the LED is configured to indicate the manual initiating device has been tested.

6. The device of claim 1, wherein the controller is configured to isolate the manual initiating device from other components of the fire alarm system in response to receiving the command to enter the test mode.

7. The device of claim 1, wherein the command to enter the test mode is received from a fire control panel of the fire alarm system.

8. The device of claim 1, wherein the command to enter the test mode is received from a mobile device.

9. A method of isolating a manual initiating device, comprising:
receiving, by a mobile device or a fire control panel, a selection of the manual initiating device;
placing the manual initiating device in a test mode in response to the selection of the manual initiating device; and
isolating the manual initiating device from other components of a fire alarm system in response to placing the manual initiating device in the test mode.

10. The method of claim 9, further comprising preventing the manual initiating device from triggering a fire alarm in response to isolating the manual initiating device from the other components of the fire alarm system.

11. The method of claim 9, further comprising:
receiving, by the mobile device or the fire control panel, a selection of a zone or a loop associated with the manual initiating device; and
isolating components of the fire alarm system, including the manual initiating device, in the zone or the loop in response to the selection of the zone or the loop.

12. The method of claim 9, further comprising:
receiving, by the mobile device or the fire control panel, a selection to cease the test mode; and
ceasing the test mode in response to the selection to cease the test mode.

13. The method of claim 12, further comprising activating a fire alarm of the fire alarm system in response to a switch of the manual initiating device being activated subsequent to ceasing the test mode.

14. The method of claim 9, further comprising reporting the manual initiating device was tested in response to a switch of the manual initiating device being activated subsequent to isolating the manual initiating device from the other components of the fire alarm system.

15. A fire control system, comprising:
a computing device; and
a manual initiating device configured to:
receive a command from the computing device to enter into a
test mode;
enter into the test mode in response to receiving the command;
isolate the manual initiating device from other components of a fire alarm system in response to the manual initiating device entering into the test mode; and
indicate the manual initiating device is in the test mode
in response to the manual initiating device being isolated from the other components of the fire alarm system.

16. The system of claim 15, wherein the computing device is a mobile device.

17. The system of claim 15, wherein the computing device is a fire control panel.

18. The system of claim 15, wherein the computing device is configured to transmit the command in response to the manual initiating device being within a wireless range of the computing device.

19. The system of claim 15, further comprising an additional manual initiating device configured to:
receive an additional command from the computing device; and
enter into the test mode in response to receiving the additional command.

20. The system of claim 19, wherein the additional manual initiating device is configured to:
isolate the additional manual initiating device from the other components of the fire alarm system in response to the additional manual initiating device entering the test mode; and
indicate the additional manual initiating device is in the test mode in response to the additional manual initiating device being isolated from the other components of the fire alarm system.
